(19) United States
(12) Patent Application Publication
(10) Pub. No.: US 2017/0225320 A1
(43) Pub. Date: Aug. 10, 2017

(54) GRAVITY BALANCED MONOPOD SYSTEM AND METHOD

(71) Applicant: Other Lab, LLC, San Francisco, CA (US)

(72) Inventors: Tim Swift, Albany, CA (US); Brenton Piercy, San Francisco, CA (US)

(21) Appl. No.: 15/430,128

(22) Filed: Feb. 10, 2017

Related U.S. Application Data
(60) Provisional application No. 62/293,657, filed on Feb. 10, 2016.

(51) Int. Cl. B25H 1/00; F16M 11/28

(52) U.S. Cl. CPC B25H 1/0035; B25H 1/0028; B25H 1/0042; F16M 11/28; F16M 2200/047

(57) ABSTRACT

In one aspect, the disclosure includes a monopod that comprises an elongated linear body that extends along a main axis between a top-end and a bottom-end, the body including a plurality of telescoping segments configured to allow the body to extend and contract along a length of the body by at least a second segment slidably residing within a first segment; one or more cavities defined by the body and configured to hold a fluid; and a fluid assembly that is configured to allow the fluid to pass from a fluid source and into the one or more cavities under the control of a fluid-control interface.

### CROSS-REFERENCE TO RELATED APPLICATIONS

This application is a non-provisional of U.S. Provisional Application Ser. No. 62/293,657 filed Feb. 10, 2016, which application is hereby incorporated herein by reference in its entirety and for all purposes.

### BRIEF DESCRIPTION OF THE DRAWINGS

FIG. 1a is an example side-view of a gravity balanced monopod coupled with a work-tool in accordance with one embodiment.

FIG. 1b is an example side-view of a gravity balanced monopod coupled with a work-tool in accordance with another embodiment.

FIG. 2a is an example side-view of a gravity balanced monopod in accordance with a further embodiment.

FIG. 2b is an example cut-away side-view of the gravity balanced monopod of FIG. 2a in a compressed configuration.

FIG. 2c is an example cut-away side-view of the gravity balanced monopod of FIGS. 2a and 2b in an expanded configuration.

FIG. 3a is an example cut-away side-view of the gravity balanced monopod of FIGS. 2a, 2b and 2c.

FIG. 3b is an example cut-away side-view of a gravity balanced monopod in accordance with a yet another embodiment.

FIG. 4a is an example cut-away side-view of a gravity balanced monopod in accordance with an embodiment.

FIG. 4b is an example cut-away side-view of the gravity balanced monopod of FIG. 4a in a collapsed configuration compared to FIG. 4a.

FIG. 5a is an example side-view of a gravity balanced monopod in accordance with another embodiment that comprises a plurality of clamps.

FIG. 5b is an example side-view of the gravity balanced monopod of FIG. 5a in a collapsed configuration compared to FIG. 5a.

FIG. 6 is an example side-view of a gravity balanced monopod in accordance with a further embodiment.

FIG. 7a is an example close-up side-view of a top portion of the gravity balanced monopod of FIG. 6.

FIG. 7b is an example close-up side-view of a bottom portion of the gravity balanced monopod of FIG. 6.

FIG. 8 is an example side-view of a gravity balanced monopod in accordance with a yet another embodiment.

FIG. 9a is an example close-up side-view of a top portion of the gravity balanced monopod of FIG. 8.

FIG. 9b is an example close-up side-view of a bottom portion of the gravity balanced monopod of FIG. 8.

FIG. 10 is an example flow chart illustrating an embodiment of a method of performing work with a work-tool coupled to a monopod.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The present disclosure illustrates and describes example designs and demonstrates the example implementations of various example embodiments of a gravity balancing monopod 100. Some examples can use a nearly-constant force spring to offset the gravity loading of a load fixed to an end of the monopod 100 as describe herein. Various embodiments comprise a spring in the monopod 100 that can be designed to provide a nearly constant force about a force that can be manually set by the user (the nominal force). An embodiment of this design uses a gas spring where the pressure inside one or more chamber can be manually set by the user through adjusting a valve connected to a contained high pressure source such as a carbon dioxide tank.

In one preferred embodiment, the design comprises a gas spring with adjustable pressure, but other embodiments can comprise one or more mechanical spring with a set preload, and the like. The spring assembly of such embodiments can be designed and configured in various suitable ways, including various suitable configurations of the stroke, spring bore, allowable deviation from constant force, and the like.

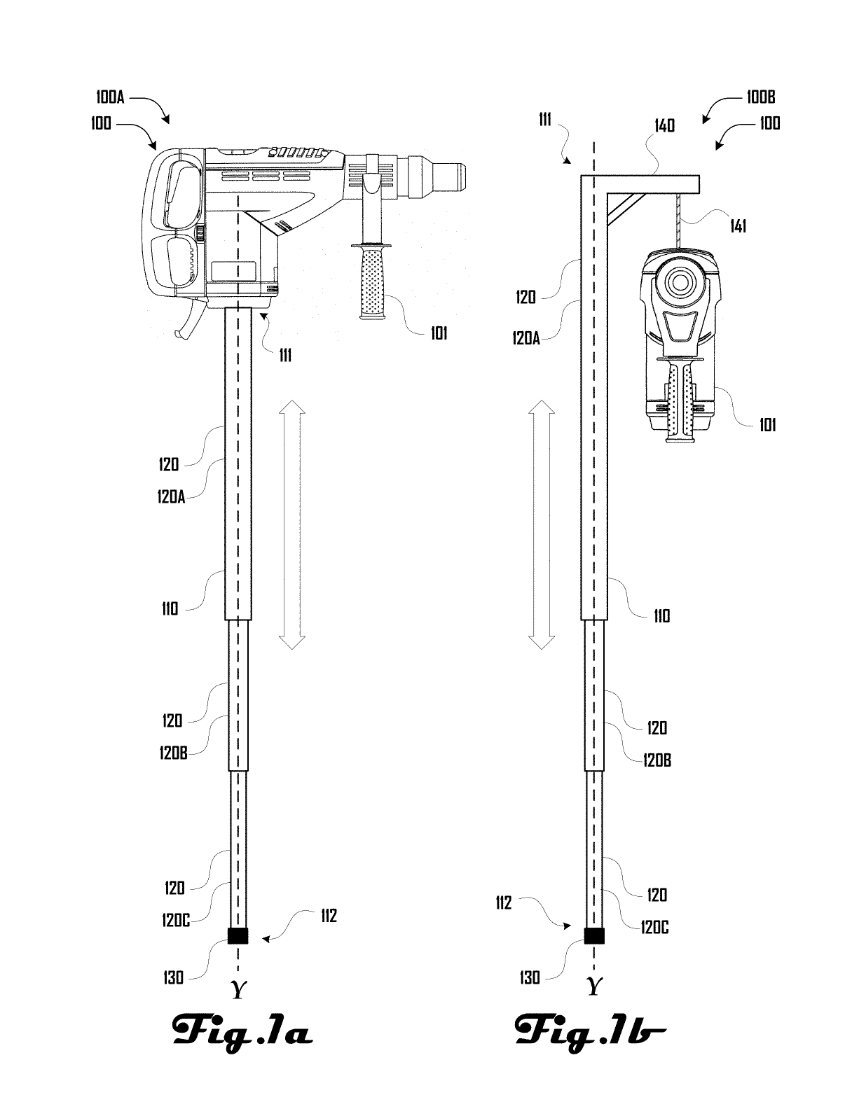

Turning to FIGS. 1a and 1b two example embodiments 100A, 100B of a gravity balanced monopod 100 are illustrated. As shown in these examples, a gravity balanced monopod 100 can comprise a body 110 that extends along a main axis Y between a top-end 111 and a bottom-end 112. The gravity balanced monopod 100 can comprise a plurality of telescoping segments 120, which as described herein, can be configured to allow the body 110 to extend and contract along the length of the body 110 by having some segments 120 slide within other segments 120.

For example, in the embodiments 100A, 100B a gravity balanced monopod 100 is shown comprising a first, second and third segment 120A, 120B, 120C with the first segment 120A being at the top-end 111, the third segment 120C being at the bottom-end 112, and the second segment 120B being disposed between the first and third segments 120A, 120B. In these examples, the first segment 120A has a larger diameter than the second segment 120B, and the second segment 120B has a larger diameter than the third segment 120C. Such a configuration can allow for the third segment 120C to slidably telescope within the second segment 120B, and for the second segment 120B to slidably telescope within the first segment 120A.

Although the examples shown herein illustrate example embodiments having successively smaller segments 120 toward the bottom-end 112, other configurations are within the scope and spirit of the present disclosure. For example, further embodiments can include successively larger segments 120 toward the bottom-end 112; a larger middle segment 120B between smaller end segments 120A, 120C; a smaller middle segment 120B between larger end segments 120A, 120C, and the like. Additionally, while examples shown herein illustrate monopods 100 having two or three segments 120, it should be clear that further embodiments can include any suitable plurality of segments 120 including four, five, six, seven, eight, and the like.

In various embodiments, a gravity balanced monopod 100 can be configured for assisting with the lifting of loads. In some embodiments, the monopod 100 can provide the ability for an operator to counteract a desired load through pushing on the ground. For example, as described in more detail herein, the monopod 100 can use a gas spring to provide a substantially constant force that can be set by the operator over a set range of motion. The telescoping segments 120 can allow the monopod 100 to move the constant force range as desired.

An implementation of various embodiments is to hold a work-tool. In this event, the target force output from the monopod 100 can be set to counteract the gravity load associated with the work-tool or other load. For example, FIG. 1a illustrates a work-tool 101 (i.e., a hammer drill) coupled at the top-end 111 of the monopod 100A with at least a portion of the work-tool 101 being coincident with the main-axis Y of the monopod 100. In another example, FIG. 1b illustrates a work-tool 101 coupled proximate to the top-end 111 of the monopod 100B without the work-tool 101 being coincident with the main-axis Y of the monopod 100 and being suspended from a cable 141 that is coupled to an arm 140 that extends from the top-end 111 of the monopod 100.

In such examples, the monopod 100 can allow a user to naturally manipulate and operate the work-tool 101 without having to bear the weight of the work-tool 101. In other words, the monopod 100 can take the weight of the work-tool 101 and the range of motion provided by the telescoping segments 120 allows for natural manipulation and operation of the work-tool 100 within a desired target work area.

The monopod 100 can extend to a foot 130 at the bottom-end 112, which can be configured to engage the ground or other surface below a target work area. In some embodiments, the foot 130 can comprise a rubber bumper or other suitable structure configured to engage a surface. In further embodiments, the foot 130 can comprise other suitable structures such as tripod, pin, bearing, wheel, or the like. The foot 130 can coupled to the ground directly, or via a structure, or can engage the ground but be movable. In some embodiments, the bottom-end 112 can be coupled to a user via a harness or other system.

Additionally, while a hammer drill work-tool 101 is shown in FIGS. 1a and 1b, further embodiments can include any other suitable type of work-tool, including a paint-gun, chisel, reciprocating saw, soldering iron, sander, chainsaw, circular saw, heat-gun, hedge trimmer, impact driver, jigsaw, nail gun, pressure washer, vacuum, or the like. Also, further embodiments can relate to bearing, moving, lifting or otherwise manipulating any suitable load. In still further embodiments, a force setting of the monopod can be set greater than the attached load which provides a near constant upward force on the load. For example, such a configuration can be desirable for applying additional force during tasks such as drilling, driving, sawing, or the like.

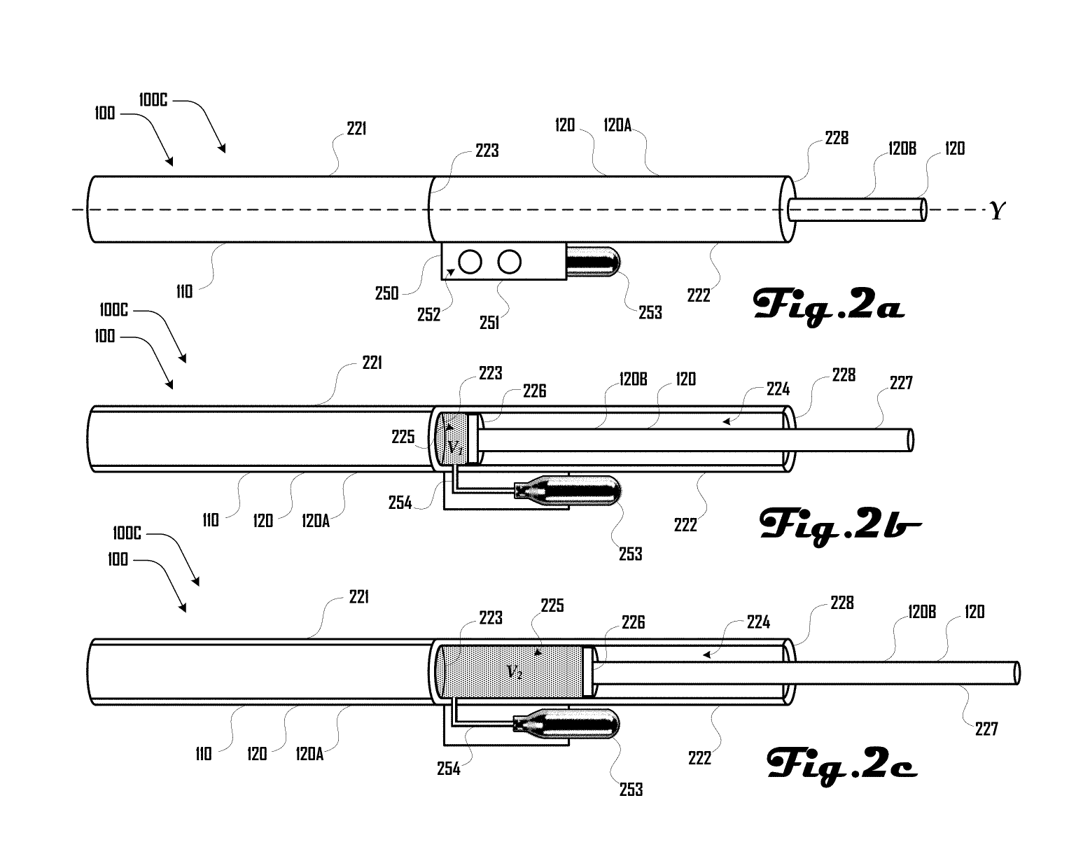

Turning to FIGS. 2a-c, a further embodiment 100C of a gravity balanced monopod 100 is illustrated that comprises a body 110 having a first segment 120A and a second segment 120B that slidably resides within the first segment 120A. The first segment 120A includes a base 221 and a cavity portion 222 that are separated by a wall 223 with the cavity portion 222 defining a cavity 224.

As illustrated in FIGS. 2b and 2c, a volume V of fluid 225 can be disposed within a portion of the cavity 224 between the wall 223 and a piston 226 of the second segment 120B. A shaft 227 can extend from the piston 226 and out an end-cap 228 of the first segment 120A. The piston 226 can slidably reside within the cavity 224, which can change the volume V of the cavity 224 in which the fluid 225 resides. For example, FIG. 2b illustrates the fluid 225 inhabiting a smaller volume V₁ than the volume V₂ illustrated in FIG. 2c.

The volume V can expand or contract based on various factors including force exerted on the shaft 227 (and piston 226) and force exerted on the top-end 111. For example, where a work-tool 101 exerts a downward force on the top-end 111 (e.g., as illustrated in FIGS. 1a and 1b) with the bottom-end 112 engaging the ground, such a force can compress a volume V of fluid 225 in the cavity 224 where the fluid 225 is a compressible fluid such as a gas. Additionally, the amount of fluid can affect the volume V that fluid 225 occupies within the cavity 224. Also, stiffness of the monopod 100 can be adjusted by modifying the overall dead volume (i.e., the volume of air that is present during the fully collapsed or compressed state), relative to the change in volume (i.e., swept volume).

Accordingly, the amount of a gas within the cavity 224 between the wall 223 and the piston 226 can define the volume V that results when a given load is applied to the top-end 111 of the monopod 100 (e.g., by a work-tool 101 or the like). In other words, the amount of gas within the cavity 224 between the wall 223 and the piston 226 can dictate the length at which the monopod 100 assumes a compression equilibrium under the load applied to the top-end 111. However, as discussed in more detail herein, the compressibility of gas will allow for movement of the load (e.g., the work-tool 101) by a user within a range of the equilibrium length or height.

The stroke of one or more pistons 226 within a respective cavity 224 can correlate to how far the monopod 100 provides gravity balance functionality. Different applications, or user preferences, may involve different stroke lengths, but some preferred embodiments include a stroke of 6, 8, 10, 12, 14, 16, 18, 20, 22, 24, 26, 28, 30, 32, or 34 inches. Accordingly, preferred embodiments of a monopod 100 can be configured to have a stroke within the range of any of such strokes.

Fluid 225 can be introduced into or removed from the cavity 224 in various suitable ways. For example, FIGS. 2a-c illustrate a monopod 100 that comprises a fluid assembly 250 having a housing 251, a fluid-control interface 252 and fluid source 253 that is operable to store fluid 225. Fluid can pass between the fluid source 253 and the cavity 224 via a fluid line 254 and under the control of the fluid-control interface 252. As discussed herein, various suitable fluid-control interfaces 252 are contemplated within the scope and spirit of the present disclosure including any suitable assembly of valves and the like, configured to control the flow of fluid within the one or more fluid line 254.

For example, one or more pressures in the segments 120 can be modified in a number of ways. In the example of FIGS. 2a-c, the pressure can be supplied by an affixed CO₂ gas canister or cylinder 253 that can be controlled by the operator by manually operating a valve associated with the CO₂ gas canister. The pressure can then be released by the operator through the use of a manual release valve. This can allow the pressure to be brought up to a target amount and then released when stowed.

In various embodiments, the fluid source 253 can be completely self-contained within the monopod 100. In other words, the fluid source 253 can part of a unitary structure of the monopod 100 in contrast to an external fluid source such as an external compressor system or the like. Stated another way, the fluid source 253 of various embodiments can comprise a limited volume of fluid in contrast to rechargeable external fluid source such as an external compressor system.

In another embodiment, the pressure can also be supplied by a hand pump (e.g., a portable bike pump, or the like). Another embodiment can provide the operator with a regulator that has a series of pressure settings that correspond to regulator settings where the operator can manually set the amount of force required by the task. Yet another embodiment can involve a valve that controls gas flow from a high pressure source to provide a desired output force.

Additionally, any suitable fluid can be used in various embodiments, including gas fluids such as carbon dioxide, air, helium, nitrogen, argon, and the like. Additionally, further embodiments can use liquid fluids such as water, oil, and the like. Some preferred embodiments include the use of standard (e.g., ISO standard) fluid cartridges including an 8 gram, 12 gram, 16 gram, 24 gram, or 88 gram carbon dioxide cylinder.

In some embodiments of a gas spring, it can be desirable for the gas pressure to remain substantially constant or within a narrow range at fully compressed and fully extended configurations. The change in the gas pressure in a passive fixed chamber can be dictated by the ratio of the gas volumes in the two configurations. In some embodiments, the ratio of volumes (V_{extend} to V_{collapse}) can be large and can lead to a large change in operating pressure, which can be undesirable in certain embodiments. To combat this, further embodiments can include a larger nominal volume that allows the effect of the change in volume to be reduced and result in a smaller volume change.

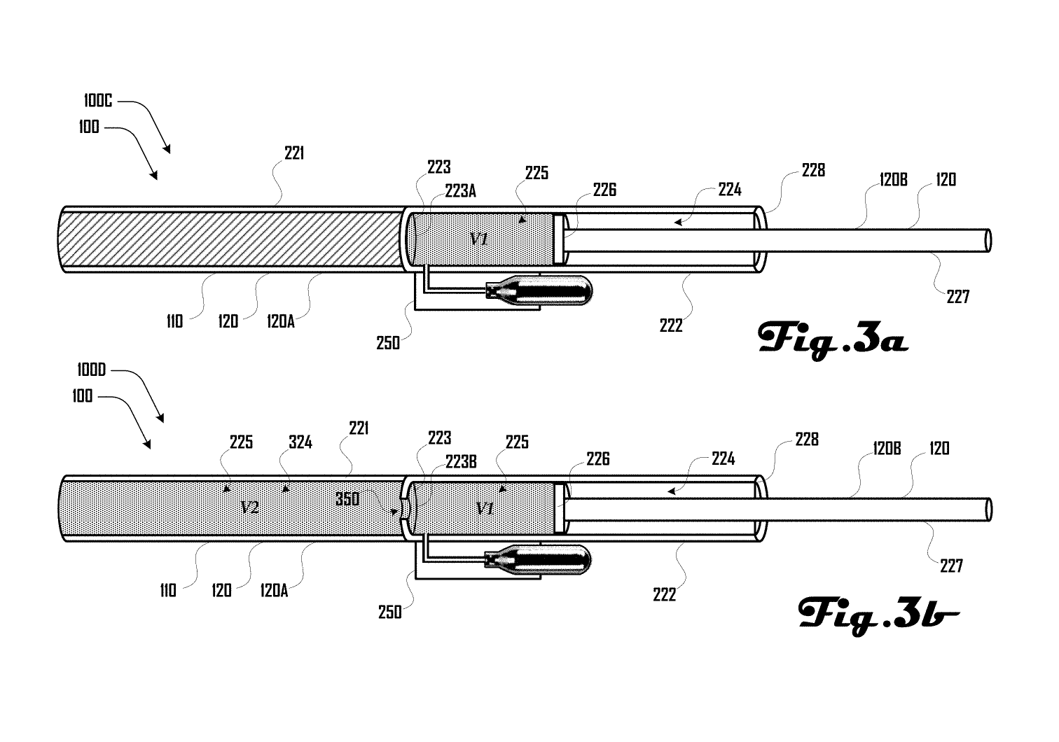

For example, FIGS. 3a and 3b illustrate two example embodiments 100C, 100D having different nominal volumes. FIG. 3a is the same embodiment 100C illustrated in FIGS. 2a-c, which is shown having volume V1 of fluid 225 between the wall 223 and piston 226 in an extended configuration. In this example, an impermeable wall 223A separates the cavity 224 from the base 221, which may include a separate cavity, a solid space that does not define a cavity, or the like.

However, FIG. 3b illustrates an embodiment 100D having a permeable wall 223B having a port 350 that allows fluid to inhabit a second cavity 324 defined by the base 221 having volume V2. Accordingly, while volume V1 can change (e.g., as illustrated in FIGS. 2b and 2c), volume V2 can remain constant and thus the ratio of extended and collapsed volumes (V_{extend} to V_{collapse}) can be smaller than the embodiment 100C shown in FIG. 3a which only includes volume V2.

Although FIG. 3b illustrates an example embodiment of 100D having a wall 223B with a port 350 that allows fluid to pass into the second cavity 324, this should only be construed as being only one example embodiment. Further embodiments can include a wall 223 having any other suitable configuration or with any suitable plurality of ports 350, or the like. In some examples, the wall 223 can provide a backstop for the piston 226, which can limit the range of motion or stroke of the piston to volume V1 within the first cavity 224. For example, in the context of FIG. 3b, such a configuration can allow volume V2 to remain constant by limiting the collapsed stroke of the piston 226 to a configuration where the piston 226 engages the wall 223.

Other embodiments can comprise alternative and/or additional components to reduce the pressure variation throughout the stroke. One example can include reducing the stroke of the one or more segments 120 that define the gravity balanced section. Other embodiments can include one or more subsequent segment 120 including an internal cavity and/or a large bore. Such examples can enable a smaller reduction in volume for the same stroke by maintaining the fixed volume in smaller package.

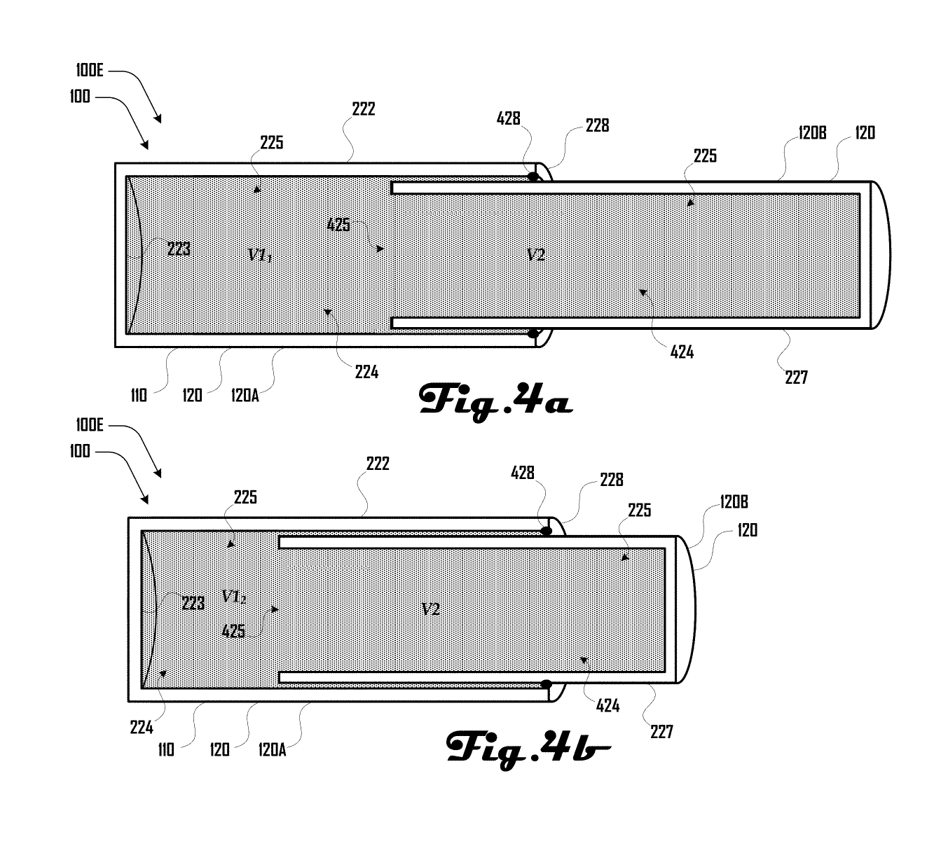

For example, FIGS. 4a and 4b illustrate an embodiment 100E of a monopod 100 that comprises a first and second segment 120A, 120B that respectively define a first and second cavity 224, 424. FIG. 4a illustrates the monopod 100 in an expanded configuration and FIG. 4b illustrates the monopod 100 in a collapsed configuration. As illustrated in FIGS. 4a and 4b, the second segment 120B is configured to slidably reside within the first segment 120A, with the second segment 120B defining the second cavity 424, which opens into the first cavity 224 at an end-port 425. The first cavity 224 defines a first volume V1 between the wall 223 and the end-port 425. The second cavity 424 defines a second volume V2.

In this example, the shaft 227 of the second segment 120B is configured to slidably engage a seal 428 (e.g., a gasket) at the end-cap 228 of the first segment 120, which allows fluid to be held within the first and second cavity 224, 424 under pressure. The total volume within the first and second cavity 224, 424 is defined by the second volume V2 and by the first volume V1, which is a larger volume V1₁ in the expanded configuration of FIG. 4a and a smaller volume V1₂ in the compressed configuration of FIG. 4b. Accordingly, volume V2 remains constant with volume V2 changing based on the configuration of the monopod 100. In contrast to a configuration where a piston 226 and shaft 227 (e.g., FIGS. 2a-c) do not define a cavity, having the second segment 120B define a cavity 424 can reduce the pressure variation throughout the stroke of the first and second segment 120A, 120B.

In other embodiments, the bore or diameter of the segments 120 of a gas spring defined by the monopod 100 can be modified to target a desired operating pressure for a desired operating range. For a fixed operating load, in some embodiments, a larger cylinder bore can allow for lower chamber pressures or can allow for such embodiments to be used for higher loads.

Although various examples embodiments of a monopod 100 having a plurality of segments 120 that can define a fluid spring are shown, this should not be construed to be limiting on the wide variety of embodiments within the scope and spirit of this disclosure that can be employed for defining a fluid spring. For example, some embodiments of a monopod 100 can have any suitable plurality of segments 120 with such segments defining or not defining a cavity in various suitable configurations as illustrated in FIGS. 3a, 3b, 4a and 4b. In other words, the example embodiments of FIGS. 3a, 3b, 4a and 4b can be combined to generate monopods 100 having three, four, five, six (or other suitable plurality) of segments 120 having one or more configuration as illustrated in FIGS. 3a, 3b, 4a and 4b or other examples described herein.

Accordingly, segments 120 can define movable fluid cavities in various suitable ways. For example, two or more segments 120 can operate as a gas spring found in conventional lift gate operations. These gas springs can comprise a single sealed chamber with a shaft 227 (e.g., as shown in FIGS. 2b and 2c). However, in some embodiments, a seal can be on the shaft 227 instead of the piston 226 as in FIGS. 2b and 2c. Additionally, in some embodiments, a piston 226 can be ported to allow limited fluid flow from one side to the other. In some such embodiments, the change in volume may only be due to the volume of the external shaft 227 that slides in and out of the cavity 224.

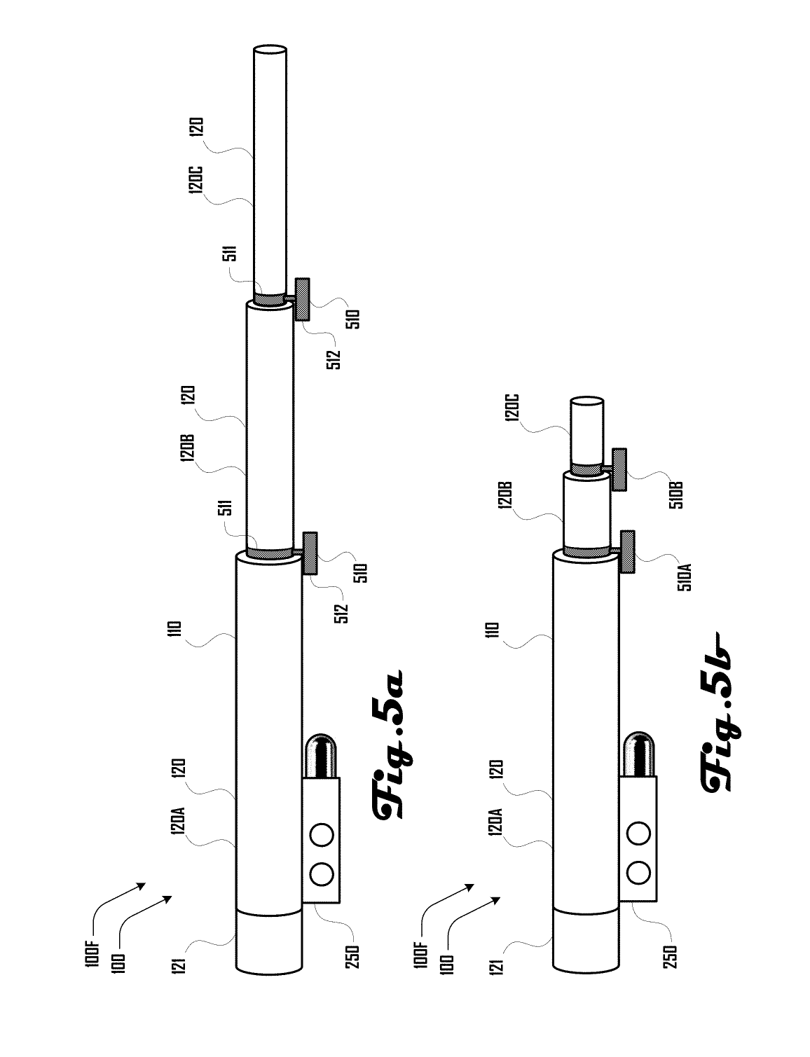

As discussed herein, various embodiments of a monopod 100 can be optimized to specify the spring design specifics as described herein above such as stroke, cylinder bore, and pressure variation. In some implementations the monopod 100 can be configured for use over a larger range of motion. In this event, we will consider an example embodiment that is designed for a 12 inch stroke of gravity balance. This example monopod 100 can be configured to move freely through the 12 inch stroke, but if a work-tool 101 (FIGS. 1a and 1b) is held at the top-end 111 and the gravity balanced monopod 100 is desired for be used over a larger range, then further configuration can be desirable as illustrated in the example embodiment 100F of FIGS. 5a and 5b.

This example embodiment 100F includes a mechanical telescoping feature through a series of clamps 510 that allows the user to manually set the range of where the 12 inches of gravity balanced functionality can exist. For example, the clamps 510 can include a collar 511 that surrounds a portion of a respective segment 120, with a knob 512 that can be tightened to fix the collar 511 in place. In other words, the clamps 510 can be movable along the length of a respective segment 120 when loose and then can be fixed in a position on the segment 120 to adjust the range of motion of the segments 120.

Some embodiments can include a telescoping capability that engages and disengages with the press of a button, or the like. For example, in one embodiment, a second segment 120B can be locked within a first segment 120A at a given extension configuration (e.g., in a compressed or extended configuration) and unlocked by pressing a button (e.g., like a telescoping umbrella or retracting ballpoint pen). In another example, compressing a second segment 120B within a first segment 120A can cause the segments 120 to lock at a certain position, and the first and second segment 120A, 120B can be unlocked by depressing the segments 120 past this locked position.

Such examples can apply to single pairs of segments or can be applied to a plurality of pairs of segments at the same time. For example, a single button can unlock a plurality of locked segment pairs or further compressing a locked monopod 100 past a locked configuration can unlock a plurality of locked segment pairs. Yet another embodiment involves a controlled telescoping capability where the telescoping capability is controlled by one or more motor, ratchet, or the like.

To help minimize the amount of compressed gas needed to operate over long working shifts, some embodiments of the monopod 100 can include an apparatus to lock the constant force spring in its retracted position. This can effectively minimize the length of the device for easy maneuvering in tight quarters. This lock can be similar to the telescoping locking mechanisms discussed above or can comprise a valve, which when closed, prevents the flow of fluid in or out of one or more fluid sources 253 or one or more cavities defined by one or more segment 120. One other embodiment of a shaft lock comprises a hydraulic shaft collar that can prevent the sliding of the cylinder shaft during transport. Similar locking mechanisms such as electromechanical brakes can also be utilized, which may allow locking at any point within the stroke of the monopod 100 and not just at specific points of the stroke of one or more segments 120.

An end effector can be coupled to an end 111, 112 of a monopod 100 in various embodiments, which can be tailored to the user's application. In such embodiments, various end effectors can attach to the monopod 100 through a fixture such as a threaded rod of a known thread pattern. In the example embodiments of FIGS. 1a and 1b, the end effector being used can be a work-tool holding end effector (not shown) that allows a specific work-tool 101 to be fixed to the monopod 100. Other embodiments can include a gimbal-mounted tool holding end effector that can allow the specific work-tool 101 to be securely connected while allowing reasonably unrestrained rotation in all axes. In a similar fashion, other embodiments can include specific attachment variations at the bottom-end 112 of the gravity balanced monopod. As discussed herein, various embodiments of these base fixtures can include but are in no way limited to the following: a soft base to absorb impacts with the ground, a tripod base, a foot pedal base, an omni-directional wheel, a powered wheel to assist with balance, or a torque source to assist with balancing the monopod.

One embodiment can affix the gravity balanced monopod 100 to a waist belt while other embodiments may affix the monopod 100 to a torso harness to support with stability. Another embodiment of the monopod 100 may not be targeting constant force that offsets gravity of a load but that is some delta from this weight to provide a near constant upward or downward force from the connected load. Yet another embodiment can target a non-constant force output and instead be targeting a linear force profile through the stroke of the plurality of segments 120.

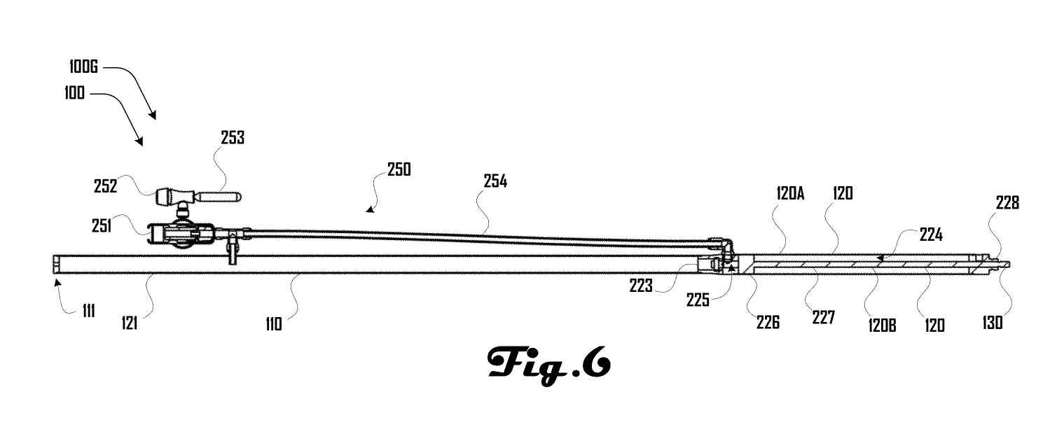

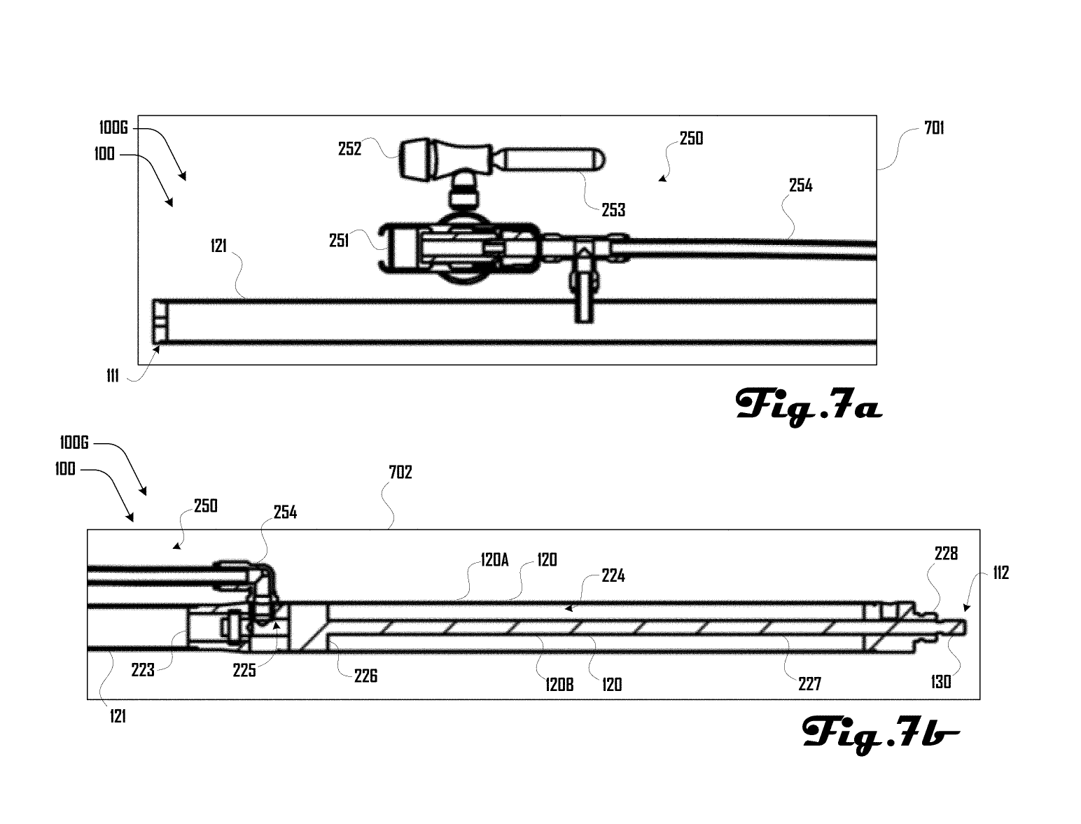

Turning to FIGS. 6, 7a and 7b a further embodiment 100G of a monopod 100 is illustrated with FIGS. 7a and 7b showing a respective top portion 701 and bottom portion 702 of the monopod 100G illustrated in FIG. 6. As shown in FIGS. 6, 7a and 7b, this example embodiment 100G includes a linear elongated body 110 that extends between a first and second end 111, 112. The body 110 comprises a first and second segment 120A, 120B with an elongated base 121 extending from the first segment 120A. In this example, the base 121 is shown being longer than the first and second segment 120A, 120B combined in the compressed configuration shown (and longer than the first and second segment 120A, 120B combined in an expanded configuration, which is not shown).

A volume of fluid 225 can be disposed in the within a portion of a cavity 224 between a wall 223 of the first segment 120A and a piston 226 of the second segment 120B. A shaft 227 can extend from the piston 226 and out an end-cap 228 of the first segment 120A. The piston 226 can slidably reside within the cavity 224, which can change the volume of the cavity 224 in which the fluid 225 resides.

The monopod 100 further comprises a fluid assembly 250 having a housing 251, a fluid-control interface 252 and fluid source 253 that is operable to store fluid 225. Fluid can pass between the fluid source 253 and the cavity 224 via a fluid line 254 and under the control of the fluid-control interface 252, which in this example comprises a valve-control knob. Additionally, this example embodiment 100G illustrates an example wherein the fluid line 254 is at least longer than the first and second segment 120A, 120B combined in the compressed configuration. Additionally, the fluid line 254 is shown being disposed exclusively external to the body 110 of the monopod 100 aside from a small portion interfacing with the cavity 224.

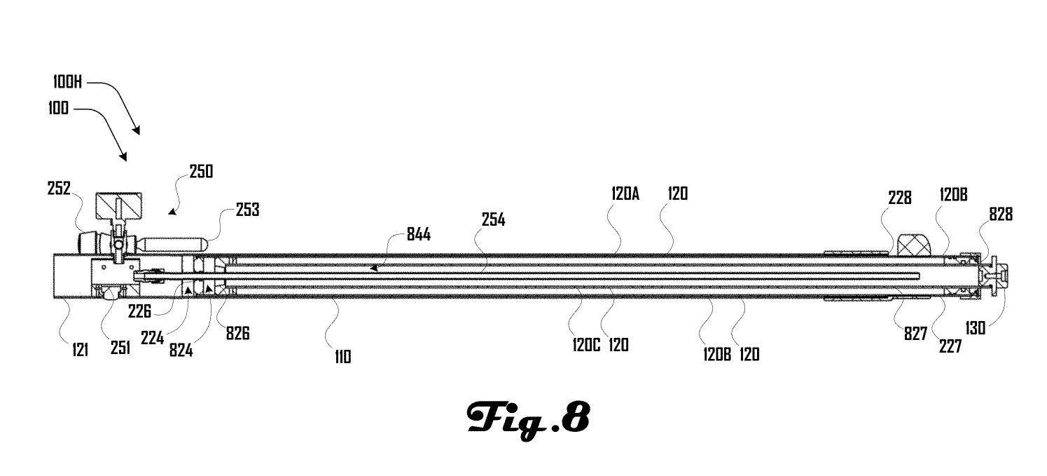

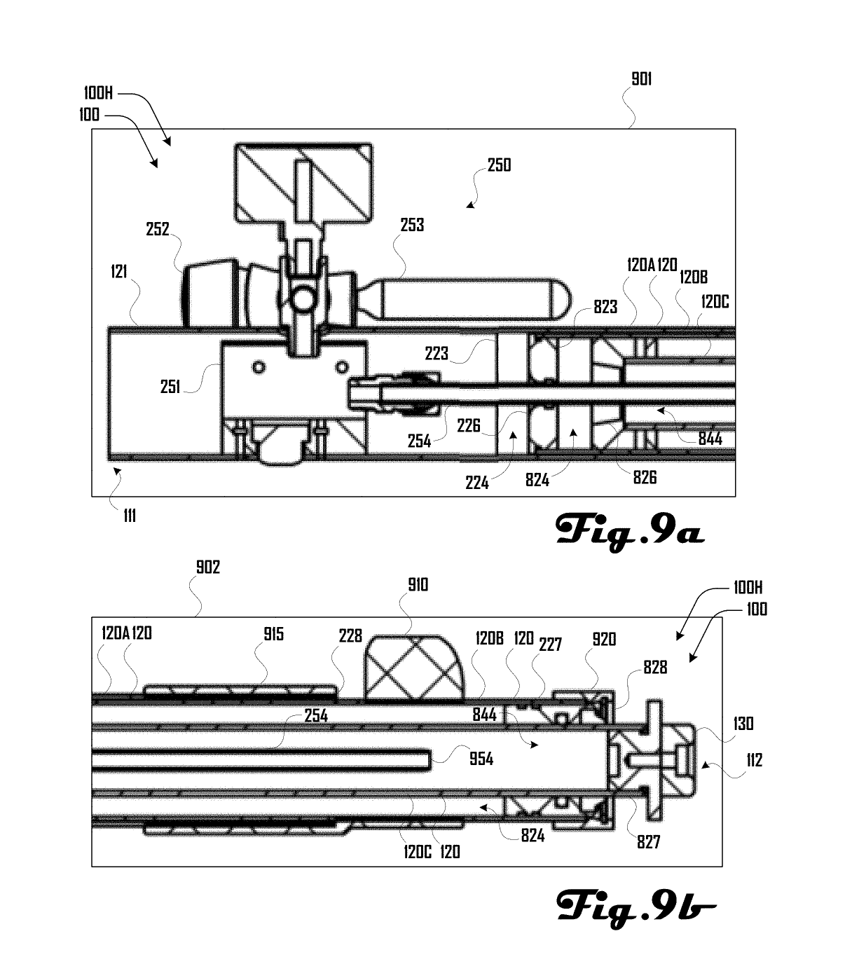

Turning to FIGS. 8, 9a and 9b a further embodiment 100H of a monopod 100 is illustrated with FIGS. 9a and 9b showing a respective top portion 901 and bottom portion 902 of the monopod 100H illustrated in FIG. 8. As shown in FIGS. 8, 9a and 9b, this example embodiment 100H includes a linear elongated body 110 that extends between a first and second end 111, 112. The body 110 comprises a first, second and third segment 120A, 120B, 120C with an elongated base 121 extending from the first segment 120A. The third segment 120C is slidably nested within the second segment 120B and the second segment 120B is slidably nested within the first segment 120A.

The first segment 120A defines a first cavity 224 in which the second segment 120B slidably resides, including a portion in which fluid resides between a first wall 223 of the first segment 120A, and a piston or second-segment end 226. The second segment 120B comprises a shaft 227 that extends out a first-segment end-cap 228.

The second segment 120B defines a second cavity 824 in which the third segment 120C slidably resides, including a portion in which fluid resides between a second internal wall 823 of the second segment 120B, and a piston or third-segment end 826. The third segment 120C comprises a shaft 827 that extends out a second-segment end-cap 828 and terminates at a foot 130 at the bottom-end 112.

A stop 910 is disposed on the shaft 227 of the second segment 120B and is configured to engage the first-segment end-cap 228, which includes a first guard 915 that encircles the shaft 227 of the second segment 120B. The second-segment end-cap 828 includes a second guard 920 that encircles the shaft 827 of the third segment 120C.

The monopod 100 further comprises a fluid assembly 250 having a housing 251, a fluid-control interface 252 and a fluid source 253. Fluid can pass between the fluid source 253 and the cavity 224 via a fluid line 254 and under the control of the fluid-control interface 252, which in this example comprises a valve-control knob. In this example, the fluid line 254 extends from the housing 251 disposed within the base 121 to a line port 954 proximate to the bottom-end 112, which is configured to introduce and/or remove fluid from the third cavity 844. In this example, the fluid line 254 extends through the base 121, out the wall 223, into the first cavity 224, though the second internal wall 823 of the second segment 120B, into the second cavity 824, through the piston or third-segment end 826 of the third segment 120C and into the third cavity 844.

In various embodiments, the third cavity 844 can communicate with the first and second cavity 224, 824 such that fluid introduced to the third cavity 844 from the line port 954 can pass into the first and second cavity 224, 824. In some embodiments, the fluid line 254 can comprise ports along the length of the fluid line 254 which are configured to separately communicate fluid into and/or out of the first, second and third cavities 224, 824, 826, even in embodiments where the first, second and third cavities 224, 824, 826 are not configured to directly communicate fluid between each other.

Additionally, as shown in FIGS. 8, 9a and 9b, the fluid line 254 can extend from the housing 251 disposed within the base 121 to the line port 954 proximate to the bottom-end 112, with the line port 954 extending past at least a portion of the end-cap 228 of first segment 120A. Additionally, the fluid line 254 can be rigid and extend though the third cavity 826 without engaging an inner wall of the third cavity 826.

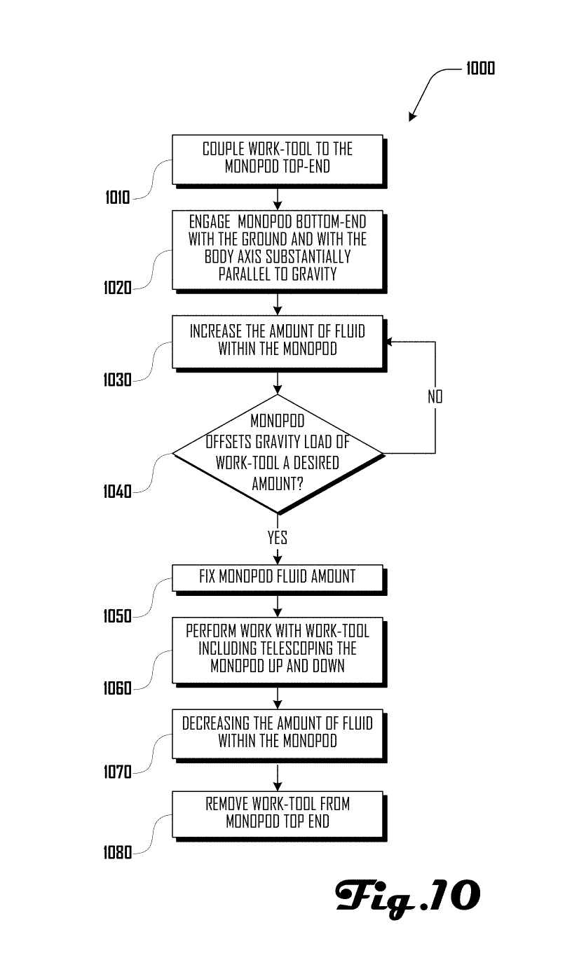

Turning to FIG. 10, a method 1000 of performing work with a work-tool 101 coupled to a monopod 100 (see e.g., FIGS. 1a and 1b) is illustrated. The method 1000 begins in block 1010 where a work-tool 101 is coupled to a monopod 100 at a top-end 111 with the monopod 100 being set at a first fluid pressure level and/or having a first amount of fluid disposed within the monopod 100. In block 1020, the bottom-end 112 of the monopod 100 is engaged with the ground and with the body axis Y of the monopod 100 substantially parallel to gravity.

For example, as discussed herein, various types of work-tools 101 or other loads can be coupled to the top-end 111 of a monopod 100 and the foot 130 or other portion of the bottom-end 112 of the monopod 100 can be engaged with the ground or other suitable surface. In various embodiments, the monopod 100 can be configured to operate substantially parallel to the force of gravity; however, maintaining the body axis Y in an exactly parallel orientation to the force of gravity may not be necessary or desirable. For example, in various embodiments, the foot 130 or other portion of the bottom-end 112 can sufficiently engage the ground or other surface such that the bottom-end 112 remains engaged with the ground even when the body axis Y is not exactly parallel with the force of gravity.

Accordingly, in various embodiments, the monopod 100 can be configured to operate within an area or radius off parallel-to-gravity based on the ability of the bottom-end 112 to remain engaged. In other words, the monopod 100 can be operated at angles away from parallel-to-gravity until such an angle causes the bottom-end to slide, dislodge or otherwise undesirably move on or lose contact with the ground. Such angles can depend on the structure of the bottom-end 112 and on the surface being engaged. For example, in some embodiments, a maximum angle away from parallel-to-gravity can include 1°, 2°, 3°, 4°, 5°, 10°, 15°, 20°, 25°, 35°, 40° or the like.

Returning to the method 1000 of FIG. 10, in block 1030, the amount of fluid and/or pressure within the monopod 100 is increased, and in block 1040, a determination is made whether the monopod 100 offsets the gravity load of the work-tool 101 a desired amount. If not, the method 1000 cycles back to block 1030 where the amount of fluid and/or fluid pressure within the monopod 100 is further increased. However, if the monopod 100 offsets the gravity load of the work-tool 101 a desired amount, then in block 1050, the amount of fluid and/or fluid pressure of the monopod 100 is fixed.

For example, the fluid pressure and/or amount of fluid in the monopod 100 can be increased via a fluid-control interface 252 of a fluid assembly 250 (see e.g., FIGS. 2a, 2b, 2c), which as described herein can include one or more knob, button or the like, which actuates a valve to allow fluid to pass from a fluid source 253 into the body 110 of the monopod 100 to increase the fluid pressure and/or amount of fluid in the monopod 100. Once a desired gravity load offset is achieved, the fluid flow can be shut off by closing the valve via the fluid-control interface 252 to fix the fluid pressure within the monopod 100.

Additionally, while the example method 1000 includes pressurizing the monopod 100 up to a desired pressure, in some examples, the monopod can be pressurized and de-pressurized for reach such a desired pressure. For example, where a desired gravity load offset is exceeded by over-pressurization, fluid can be released to bring the pressure down and to reach the desired gravity load offset.

Also, such a desired gravity load offset can be zero, positive or negative. In other words, a desired gravity load can include a positive upward force generated by an offset force greater than the gravity load; a balancing force generated by an offset force that is equal to the gravity load; or an incomplete load bearing force generated by an offset force that is less than the gravity load.

Returning to the method 1000 of FIG. 10, in block 1060 work is performed with the work-tool 101 that includes telescoping the monopod 100 up and down. For example, as discussed herein, in various embodiments, the monopod 100 can act as a gas spring, where a gravity load offset supports the gravity load generated by the work-tool 101, but where the monopod 100 remains operable to telescope within an operable range. In other words, in various embodiments, the monopod 100 can support the weight of the work-tool 101, but still allow vertical freedom of movement so that a user can use the work-tool 101 in a more natural manner instead of being limited to a single height.

Returning again to the method 1000, in block 1070, the monopod 100 is depressurized and/or the amount of fluid within the monopod 100 is decreased, and in block 1080, the work-tool 101 is removed or de-coupled from the top-end 111 of the monopod 100. For example, once a user has completed work with the work-tool 101, the user can de-pressurize the monopod 100 and remove the work-tool 101 so that the work-tool 101 and monopod 100 can be stored, transported or the like.

Removability of the work-tool 101 can be desirable so that the work-tool 101 can be used independently of the monopod 100 and so that the monopod 100 can be used with different work-tools 101 or other loads. Additionally, the ability to select different pressures for a monopod 100 and different desired gravity load offsets can be desirable so that a user can accommodate a wide variety of work-tools 101 that can be coupled with the monopod 100 under various working conditions in different working environments.

De-pressurization of the monopod 100 can be done in various suitable ways including via venting fluid into the environment or via venting fluid back into the fluid source 253 or other storage container. Such de-pressurization can occur via the fluid-control interface 252 of the fluid assembly 250 or the like.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A method of performing work with a work-tool coupled to a gravity-balanced monopod, the method comprising:
coupling a work-tool to a monopod at a top-end, the monopod comprising:
an elongated linear body that extends along a main axis between the top-end and a bottom-end, the body including a plurality of telescoping segments configured to allow the body to extend and contract along a length of the body by at least a second segment slidably residing within a first segment,
one or more cavities defined by the body and configured to hold a compressible gas, and
a gas assembly that includes a gas-control interface, a gas source storing a compressible gas, and a gas line that allows the compressible gas to pass between the gas source and the one or more cavities and under the control of the gas-control interface;
engaging the monopod bottom-end with a ground surface and with the main axis aligned substantially parallel to a force of gravity;
increasing an amount of the compressible gas within the one or more cavities by introducing the compressible gas into the one or more cavities, by actuating the gas-control interface, until the monopod offsets a gravity load of the work-tool;
fixing the amount of the compressible gas within the one or more cavities by actuating the gas-control interface;
performing work with the work-tool, including expanding and contracting the monopod along the length of the body by at least the second segment sliding within the first segment and with the monopod offsetting the gravity load of the work-tool;
decreasing the amount of the compressible gas within the one or more cavities by actuating the gas-control interface; and
de-coupling the work-tool from the monopod top-end.

2. The method of claim 1, wherein the monopod body further comprises a third segment slidably residing within the second segment.

3. The method of claim 1, wherein the compressible gas is held within a first volume of a first portion of a first cavity defined by the first segment, a first wall defined by the first segment, and a first piston defined by the second segment, with the first piston slidably residing within the first cavity and configured to change the first volume of the first portion.

4. The method of claim 3, wherein the first wall further comprises a gas port that communicates with a base cavity defined by the first segment, and wherein the compressible gas is further held within the base cavity.

5. The method of claim 3, wherein the monopod body further comprises a third segment slidably residing within the second segment, and
wherein the compressible gas is further held with a second volume of a second portion of a second cavity defined by the second segment, a second wall defined by the second segment, and a second piston defined by the third segment, with the second piston slidably residing within the second cavity and configured to change the volume of the second portion.

6. The method of claim 5, wherein the gas line is disposed within the monopod body and wherein the gas line extends through the first wall, into the first cavity, though the second wall of the second segment, into the second cavity, through the second piston of the third segment and into a third cavity defined by the third segment.

7. The method of claim 5, wherein the gas line terminates at a line port and extends past at least a portion of an end-cap of the first segment.

8. The method of claim 1, wherein the gas source is completely self-contained within the monopod such that the gas source is part of a unitary structure of the monopod.

9. A method of performing work with a work-tool coupled to a gravity-balanced monopod, the method comprising:
coupling a work-tool to a monopod at a top-end, the monopod comprising:
an elongated linear body that extends along a main axis between the top-end and a bottom-end, the body including a plurality of telescoping segments configured to allow the body to extend and contract along a length of the body by at least a second segment slidably residing within a first segment,
one or more cavities defined by the body and configured to hold a fluid, and
a fluid assembly that is configured to allow the fluid to pass from a fluid source and into the one or more cavities under the control of a fluid-control interface;
increasing an amount of the fluid within the one or more cavities by introducing the fluid into the one or more cavities, by actuating the fluid-control interface, until the monopod offsets at least a portion of a gravity load of the work-tool; and
performing work with the work-tool, including expanding and contracting the monopod along the length of the body by at least the second segment sliding within the first segment and with the monopod offsetting at least a portion of the gravity load of the work-tool.

10. The method of claim 9, wherein the monopod body further comprises a third segment slidably residing within the second segment.

11. The method of claim 9, wherein the fluid is held within a first volume of a first portion of a first cavity defined by the first segment, a first wall defined by the first segment, and a first piston defined by the second segment, with the first piston slidably residing within the first cavity and configured to change the volume of the first portion.

12. The method of claim 11, wherein the first wall further comprises a fluid port that communicates with a base cavity defined by the first segment, and wherein the fluid is further held within the base cavity.

13. The method of claim 11, wherein the monopod body further comprises a third segment slidably residing within the second segment, and
wherein the fluid is further held with a volume of a second portion of a second cavity defined by the second segment, a second wall defined by the second segment, and a second piston defined by the third segment, with the second piston slidably residing within the second cavity and configured to change the volume of the second portion.

14. A monopod comprising:
an elongated linear body that extends along a main axis between a first-end and a second-end, the body including a plurality of telescoping segments configured to allow the body to extend and contract along a length of the body by at least a second segment slidably residing within a first segment;
one or more cavities defined by the body and configured to hold a fluid; and
a fluid assembly that is configured to allow the fluid to pass from a fluid source and into the one or more cavities under the control of a fluid-control interface.

15. The monopod of claim 14, wherein the monopod body further comprises a third segment slidably residing within the second segment.

16. The monopod of claim 14, wherein the fluid is held within a volume of a first portion of a first cavity defined by the first segment, a first wall defined by the first segment, and a first piston defined by the second segment, with the first piston slidably residing within the first cavity and configured to change the volume of the first portion.

17. The monopod of claim 16, wherein the first wall further comprises a fluid port that communicates with a base cavity defined by the first segment, and wherein the fluid is further held within the base cavity.

18. The monopod of claim 16, wherein the monopod body further comprises a third segment slidably residing within the second segment, and
wherein the fluid is further held with a volume of a second portion of a second cavity defined by the second segment, a second wall defined by the second segment, and a second piston defined by the third segment, with the second piston slidably residing within the second cavity and configured to change the volume of the second portion.

19. The monopod of claim 18, wherein at least a portion of a gas line is disposed within the monopod body and wherein the gas line extends through the first wall, into the first cavity, though the second wall of the second segment, into the second cavity, through the second piston of the third segment and into a third cavity defined by the third segment; and wherein the gas line terminates at a line port and extends past at least a portion of an end-cap of the first segment.
